(19) United States
(12) Patent Application Publication
(10) Pub. No.: US 2025/0373604 A1
(43) Pub. Date: Dec. 4, 2025

(54) COMPUTING FRAMEWORK FOR ONLINE VISITOR IDENTIFICATION THROUGH DEVICE FINGERPRINTS

(71) Applicant: PAYPAL, INC., San Jose, CA (US)

(72) Inventors: Hwiyoon Cheong, San Mateo, CA (US); Michael John Aleles, San Marcos, CA (US); Velayutham Velupillai Subramanian, Fremont, CA (US); Ravikanth Reddy Gudipati, Tracy, CA (US); Venkatesan Dasarathan, Fremont, CA (US)

(21) Appl. No.: 19/003,126

(22) Filed: Dec. 27, 2024

Related U.S. Application Data
(60) Provisional application No. 63/654,808, filed on May 31, 2024.

(51) Int. Cl. H04L 9/40

(52) U.S. Cl. CPC H04L 63/0861

(57) ABSTRACT

There are provided systems and methods for a computing framework for online visitor identification through device fingerprints. An online transaction processor may provide account authentication and/or user identity verification without requiring on-device cookies and other device-side storage of data through device fingerprints. When unknown devices access a merchant website or application, they may engage with various processes, such as accounts, checkout and payment, etc. However, users may not login, and so they may not identify available products and benefits. As such, a device fingerprinting framework may be provided to fingerprint devices based on their attributes and parameters, which may be used to associate those devices with accounts and/or past user identifications. When the devices later engage with internal or external platforms, the device fingerprint may be used to, with a high degree of accuracy, identify these devices and therefore associate them with accounts for product recommendations and logins.

### CROSS REFERENCE TO RELATED APPLICATION

This application claims priority to U.S. Patent Application No. 63/654,808, filed May 31, 2024, all of which is incorporated by reference herein in its entirety.

### TECHNICAL FIELD

The present application generally relates to automated user identification during online activities and more particularly to utilizing device fingerprints to identify known users when utilizing computing services of a service provider.

### BACKGROUND

Service providers may have large computing systems and numerous services that provide automated interfaces and interactions with different end users, such as customers, clients, internal users and teams, and the like. Users may interact with various applications, websites, and/or other digital platforms via computing devices, as well as exchange messages and content via text messaging, emails, push notifications, instant messaging, and other electronic communication channels. This includes providing and/or utilizing accounts and/or personal or private data, such as personally identifiable data (PII), know your customer (KYC) data, financial data, and the like. However, users may not always sign in to websites of the service provider and/or affiliated merchants or other third-parties, such as third-party platforms that utilize computing services of the service provider. This may be due to time and inputs required to login and/or set up an account or username with a third-party, as well as for privacy protection and/or data security. For example, merchants may utilize user data to send unwanted communications and advertisements, while fraudsters may attempt to compromise sensitive data to access and/or utilize such data for fraudulent purposes, such as to perform fraudulent electronic transaction processing or account takeover. As such, users may forego logging in, providing identifying information, or otherwise identifying themselves to merchant platforms, while still using services provided by the merchant platforms.

As such, service providers may be unaware of users utilizing their computing services and/or platforms, as well as other merchants and third parties. This may adversely affect users when service providers have certain data, processes, or activity that may be beneficial to surface, provide, and/or inform the user of during the user's online activity and/or computing service usage. Further, users may find it beneficial to log in to an account, provide personal data, and/or share private data at certain times and within certain limitations or parameters. However, conventionally this requires users to provide manual inputs or allow use of device and browser cookies to track user activity and data. This leads to inflexible user identification systems, device-side data storage that may be undesirable or non-compliant with newer rules and regulations, and poor user experiences. Thus, it is desirable for service providers to implement an automated system to detect visiting users and determine their identities without requiring manual user inputs and/or unwanted device-side data tracking code.

### BRIEF DESCRIPTION OF THE DRAWINGS

FIG. 1 is a block diagram of a networked system suitable for implementing the processes described herein, according to an embodiment;

FIG. 2 is an exemplary system architecture for managing and enforcing data privacy consent through device fingerprints, according to an embodiment;

FIGS. 3A-3E are exemplary diagrams of interactions with a device fingerprinting system and framework for online visitor identification, according to an embodiment;

FIG. 4 is a flowchart for a computing framework for online visitor identification through device fingerprints, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a computing framework for online visitor identification through device fingerprints. Systems suitable for practicing methods of the present disclosure are also provided.

When using computing platforms, applications, and websites of service providers, PII, KYC, privacy protected, and other personal, financial, or private data may be provided to the service provider by different users to establish user accounts. For example, such user data may be entered or uploaded during an account establishment or maintenance phase, while processing transactions or interacting with various computing services, users, or entities, and/or communicated via an email channel, a digital alert channel, a text message channel, a push notification channel, an instant message channel, or the like. This data may be used to identify a user to the service provider, and may also be used by the user to engage with and utilize different computing services. For example, the service provider may provide electronic transaction processing services via an online transaction processor using user or payment accounts; however, other services (e.g., social networking, microblogging, media sharing, messaging, business and consumer platforms, etc.) may also be provided based on accounts and/or past user identifications. As such, it may be beneficial to identify the user and/or have the user log in to an account when engaging with and/or utilizing the computing service of the service provider. Such services may be provided directly by the service provider, such as through websites and/or software (e.g., desktop or mobile) applications of the service provider; however, other third-parties, such as merchants, may also provide the computing services through their own websites and applications.

Users may not log in and/or provide user identification at all times, whether due to a desire to remain anonymous, not wanting to engage in manual inputs and login processes, or not being aware that the computing service offers a login and/or identification process and benefits. Identification in these instances may be difficult without requiring the use of device-side data and cookies, which may be undesirable by users and/or the service provider, limited by regulations, laws, or compliance, or otherwise not previously established.

As such, according to various embodiments, the service provider may implement a server-side computing service digital platform that utilizes device fingerprints to track devices and provide visitor device and user identification. The computing service may fingerprint a device when establishing and/or utilizing an account or providing a user identification during a past process (e.g., a guest or expedited checkout), which may be generated from and linked to corresponding device parameters, settings, features, and other data of the computing device. The fingerprint may be a unique identifier for the device, such as a hash value or algorithmically created alphanumeric string created from different device parameters using a device fingerprinting technique.

The device fingerprint may then be linked to the device and corresponding account and/or user data that may be used to identify the device and user when the device is acting as a visitor to one or more online platforms or services via a website or application. As such, when the device fingerprint is later detected, for example, when the device interacts with another application, website, and/or platform, the account and/or user data may be used for personalized interactions, content, advertisements, and the like. Third-party entities may be provided with the fingerprint for detection, as well as access to a software development kit (SDK), application programming interface (API), code packages, or the like where devices connecting to and/or interacting with their systems and platforms may be fingerprinted and/or matched to existing fingerprints. Identification of the user when visiting websites or applications may be used to determine more user-specific actions and/or provide user-specific communications, such as directed or personalized communications and/or data provided to the user in place of more generic content. As such, visitor users may be identified in a more convenient and faster manner without requiring manual inputs so that personalized data may be surfaced and/or presented to the user in a fast and efficient manner.

A service provider, which may provide services to users including electronic transaction processing such as online transaction processors (e.g., PayPal®), may allow merchants, users, and other entities to process transactions, provide payments, provide content, and/or transfer funds between these users. The user may also interact with the service provider to establish an account and provide other information for the user. Other service providers may also or instead provide computing services, including social networking, microblogging, media sharing, messaging, business and consumer platforms, etc. As such, to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant.

All of these interactions may be facilitated through user logins of the account and account usage, as well as other past user identifications of the user when utilizing the computing services of the service provider through internal and/or external applications and websites. In this regard, the service provider may utilize a device fingerprint and visitor identification system and framework to facilitate visitor user identifications so that services, offers, and other information or processes may be provided to users when detected as visiting, browsing, or utilizing different service provider or third-party applications or websites. Initially, a user may engage with the service provider, such as by establishing an account and/or using the account in the aforementioned manners, engaging with a website, application, or other digital platform, or the like. Additionally behavioral data collection may occur when a user visits a website or uses an application, where interactions including page or interface visits, viewed products, shopping behavior, and the like may be tracked. After establishing an account with PII, financial data, transaction data and/or histories, KYC data, behavioral data, and the like, the service provider may utilize device fingerprints to identify the user across platforms and with third parties. Device fingerprints may link the users, accounts, and other user data or past identifications to users, and the user may be tracked using a device fingerprint.

A device fingerprint may correspond to a unique identifier, such as a unique hash, alphanumeric identifier, or other uniquely generated string that “fingerprints” or creates a unique one-to-one correspondence to the user's device. As such, the device fingerprint may be generated using device parameters including device signals, network signals, browser signals, and/or proprietary signals and data that may be collected for devices. In this regard, device parameters may include a device make, a device model, a processor type, a screen resolution, a screen height and/or a screen width, an operating system, a browser type and/or a browser version, an Internet protocol (IP) address, and/or a media access control (MAC) address. A unique identifier creation algorithm, hashing algorithm, or other computational operation may be used to create the device fingerprint. In contrast to storing a cookie or other piece of device-side data on a device of the user, the device fingerprint may be used for uniquely identifying the user or user device when the user is engaging with the service provider or another external service provider and/or platform by identifying the user's device when used for interactions and communications.

As such, a unique string or other identifier may be generated for each device when the device is seen by and/or interacts with the service provider. This may occur during direct interactions and be associated with a particular account and/or user identification. However, merchants and other third parties may also provide device parameters and/or redirect users on their devices to the service provider for fingerprinting by the service provider. Based on the user data for the user, such as account data, past identifications, behavioral data from past interactions (including browsing, shopping, and/or transaction histories) and/or other established account, financial, or personal data, the service provider may then associate each device fingerprint unique with an account or other data used for user identification and personalized user outreach, communications, and the like.

In this regard, a user may visit and/or utilize an application or website of the service provider or a merchant initially on a computing device, where the computing device may then be redirected to, or device parameters provided to, the service provider and/or fingerprinting framework for fingerprinting. The user may proceed through an initial authentication, account establishment, and/or user identification, where device attributes and parameters are collected, and an API call is made to fingerprint the device. A response from the framework may be provided, which includes the device fingerprint and/or visitor identifier enrollment, or an acknowledgement of such processing. The fingerprint and/or visitor identifier provided may then be mapped to the corresponding account and/or past user identifications (e.g., user data provided during guest checkouts and the like). Thereafter, the framework may utilize the device fingerprint with one or more internal computing services and/or endpoints, as well as external third-party entities, service providers, and/or digital platforms.

Therefore, the service provider's system may provide an automated visitor identification framework and system designed to identify visitor users when interacting with the service provider and/or external merchants and third parties. This may be done without causing device-side data to be stored, complying with regulations while reducing data storage costs and security issues from device-side data storage. For example, when the user visits a merchant website or utilizes an application of a merchant, an SDK of the service provider may be utilized, such as embedding the SDK in a merchant website or implemented in an application software library, to gather the same or similar device attributes and/or parameters. These may be provided to the service provider or processed by the SDK to fingerprint the device. In other embodiments, such as when the user visits a webpage or application of the service provider or accesses merchant provided proprietary processes for device parameter collection, the SDK may not be required, and the device parameters may otherwise be provided to the service provider.

Once fingerprinted, the service provider may perform an account lookup and matching within a confidence value or threshold to identify the account of the visitor user based on the device being used. If multiple accounts are matched, such as when the same device has been used by multiple users (e.g., family members), a most recent account or a most used account with the device may be selected; however, other selection parameters of the account may also be used. Once the account is determined, an action may be taken with the user based on the user's interaction with the application or website and/or the user's account (e.g., past history, preferences, etc.). An action may correspond to surface or populate an option, interface clement, pop-up, or the like that may allow the user to utilize computing services of the service provider. Other actions may include notifications of offers, discounts, available items or services of interest, and the like. Thus, the user may receive a personalized experience on merchant websites without requiring a login and/or user identification with the merchant when visiting their application or website. In some embodiments, an authentication of the user may be performed and/or simplified based on detecting the device of the user via the device fingerprint. For example, a username, email address, phone number, or the like may be automatically populated on the merchant's website or in the merchant's application, or on redirection to the service provider's website/application, automatically based on detecting the fingerprint of the user's device and performing the account lookup of the account corresponding to that fingerprint. This may include simplified authentications, such as by requiring a lower trust or lowering a trust requirement (e.g., not requiring multifactor authentication or other enhanced or step-up authentication, or otherwise requesting an authentication credential at a lower trust requirement such as a PIN instead of a multifactor authentication), entering a portion of authentication information, and/or automatically authenticating the user without requiring an account login or authentication information.

As such, users and device security measures may be implemented to protect from unnecessary user logins and/or identifications with merchants and/or unknown third parties that may risk data theft or misappropriation, unnecessary or unwanted communications, and the like. Further, the framework for visitor identification may prevent device-side data from being stored on-device, which may risk malicious parties compromising and/or abusing such data. This allows for faster and more efficient visitor user identification, while minimizing data storage by individual devices and data distribution over many different devices. By reducing the manual effort for logins and providing an automated system, computing resources may be reduced and exploits or vulnerabilities in user identification and account systems. As such, an improved computing system and framework may provide efficient, optimizing, and secure account management and usage across different digital platforms, applications, and websites.

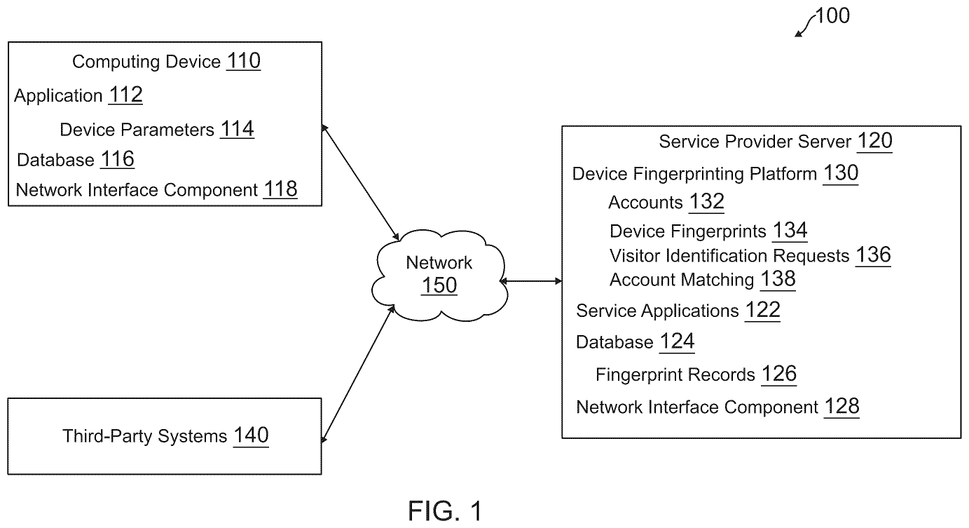

FIG. 1 is a block diagram of a networked system 100 suitable for implementing the processes described herein, according to an embodiment. As shown in FIG. 1, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110, a service provider server 120, and third-party systems 140 in communication over a network 150. Computing device 110 may be utilized by a user, customer, or the like to access a computing service or resource provided by service provider server 120 and/or third-party systems 140, which may be provided via one or more applications, websites, and/or other digital platforms. Service provider server 120 may provide various data, operations, and other functions to via network 150. In this regard, service provider server 120 may provide a fingerprinting system and operations to generate device fingerprints that may be used for user identification cross-platforms and with third-party systems 140. As such, the user of computing device 110 and their corresponding account may be identified without requiring logins and/or user identification with the computing services of service provider server 120 and third-party systems 140.

Computing device 110, service provider server 120, and third-party systems 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Computing device 110 may be implemented as a communication device that may utilize appropriate hardware and software configured for wired and/or wireless communication with service provider server 120, third-party systems 140, and/or other devices and/or servers. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Computing device 110 of FIG. 1 contains an application 112, a database 116, and a network interface component 118. Application 112 may correspond to executable processes, procedures, and/or applications with associated hardware. In other embodiments, computing device 110 may include additional or different modules having specialized hardware and/or software as required.

Application 112 may correspond to one or more processes to execute software modules and associated components of computing device 110 to provide features, services, and other operations for a user over network 150, which may include accessing and/or interacting with service provider server 120 and/or third-party systems 140, such as through applications, websites, and/or other platforms that may allow for personalized and/or targeted communications, marketing, and/or content based on user accounts and/or user identifications. In this regard, application 112 may correspond to specialized software utilized by a user of computing device 110 that may be used to access a website or a user interface of an application having data provided by service provider server 120 and/or third-party systems 140 to perform actions or operations, such as shopping, browsing, purchasing, and other activities that may benefit from personalization and/or account usage. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information (e.g., a website for a merchant), presenting the website information to the user, and/or communicating information to the website. However, in other embodiments, application 112 may include a dedicated application of service provider server 120 or other entity (e.g., a merchant of third-party systems 140).

Application 112 may be associated with account information, user financial information, and/or transaction histories. However, in further embodiments, different services may be provided via application 112, including messaging, social networking, media posting or sharing, microblogging, data browsing and searching, online shopping, and other services available through service provider server 120 and/or third-party systems 140. Thus, application 112 may also correspond to different service applications and the like that are associated with service provider server 120 and/or third-party systems 140. When using application 112, accounts and/or user identifications and data may be provided and/or generated, such as during account creation and/or login, based on different interactions by computing device 110 with service provider server 120 and/or third-party systems 140, and the like. In this regard, device parameters 114 may be provided in order to fingerprint computing device 110, as well as identify computing device 110, and a corresponding user and/or account, during visitor activity and identification with the corresponding applications and/or websites of service provider server 120 and/or third-party systems 140.

As such, device parameters 114 may correspond to different device settings, data, information, configurations, and the like, which may be provided when computing device 110 interacts with an online platform (e.g., service provider server 120 and/or third-party systems 140), as well as detected by such platforms. These may include device signals (e.g., audio settings, canvas and graphic settings, color and/or contrast settings, high-definition resolution (HDR) settings, CPU settings, memory settings, font preferences, operating system (OS) properties, language, location or region, cellular service and/or usage, etc.), network signals (transport layer security (TLS) detail, IPv4/IPv6 identifiers or other IP addresses, geolocation details, etc.), browser signals (document object model (DOM) settings, font settings, persistent storage settings, forced and inverted color settings, accessibility settings, time zone and geolocation settings, browser specific variables, session details and variables including identifiers, plugin information, etc.), and/or proprietary signals that may be determined or selected by the service provider and/or device fingerprinting system. Application 112 may therefore allow for fingerprinting of computing device 110 based on device parameters 114 during and/or after account setup, login, and/or usage with service provider server 120 and/or third-party systems 140. Further, directed and/or targeted communications and other personalized content may be output to the user via application 112 based on such fingerprints and accounts or other user preferences and historical activities.

Computing device 110 may further include database 116 stored on a transitory and/or non-transitory memory of computing device 110, which may store various applications and data and be utilized during execution of various modules of computing device 110. Database 116 may include, for example, identifiers such as operating system registry entries, cookies associated with application 112 and/or other applications, identifiers associated with hardware of computing device 110, or other appropriate identifiers, such as identifiers used for payment/user/device authentication or identification, which may be communicated as identifying the user/computing device 110 to service provider server 120.

Computing device 110 includes at least one network interface component 118 adapted to communicate with service provider server 120 and/or other devices, servers, and endpoints. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide automated operations for visitor user identification through the use of device fingerprints. In this regard, service provider server 120 includes one or more processing applications which may be configured to interact with computing device 110, third-party systems 140, and/or other internal and/or external computing services to provide device fingerprinting and identification of visitor users for personalized user experiences and computing service provision. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a device fingerprinting platform 130, service applications 122, a database 124, and a network interface component 128. Device fingerprinting platform 130, service applications 122, and other applications on service provider server 120 may correspond to executable processes, procedures, and/or applications with associated hardware. In other embodiments, service provider server 120 may include additional or different modules having specialized hardware and/or software as required.

Device fingerprinting platform 130 may correspond to one or more processes and/or modules associated specialized hardware of service provider server 120 to provide a platform and framework to establish device fingerprints and provide visitor identifications of users through the device fingerprints when their devices are detected on internal and/or external websites and applications. In this regard, device fingerprinting platform 130 may correspond to specialized hardware and/or software used by service provider server 120 to provide a system to detect user interactions with applications, websites, and/or other digital platforms of service provider server 120 through device interactions, network communications, exchanged API calls, and the like. As such, computing device 110 may be detected as engaging with service provider server 120, which may include establishing and/or logging in to an account, providing a user identification, and/or providing user data including payment or financial data or other information during electronic transaction processing. For example, accounts 132 may be generated and maintained by different users including one or more accounts for the user associated with computing device 110. In some embodiments, accounts 132 may be established by interacting with service applications 132, for example, prior to or during electronic transaction processing in order to facilitate transaction processing and payments between users, merchants, and the like. Accounts 132 may also be established for other types of online and/or digital interactions, activities, or processes. Accounts 132 may be accessible to device fingerprinting platform 130 and may be used for user identifications. Although accounts 132 are described as digital accounts, other user identifications may also be used, such as user data, identification, PII, financial information, payment cards or instruments, and the like.

In order to identify the user during future interactions with service provider server 120 and/or third-party systems 140, device fingerprinting platform 130 may request permission to generate and/or may automatically generate device fingerprints 134 for visitor user identifications when visitor identification requests 136 are received from service applications 122, third-party systems 140, and other applications or websites. Device fingerprints 134 may be based on device parameters for devices that interact with service provider server 120 or a third party including third-party systems 140. Such device parameters may be detectable by service provider server 120 over a network from the devices when interacting with service provider server 120 and/or third-party systems 140. The device parameters to generate device fingerprints 134 may include a device make, a device model, a processor type, a screen resolution, a screen height and/or a screen width, an operating system, a browser type and/or a browser version, an IP address, a MAC address, or the like. Device fingerprints 134 may be generated using a fingerprinting algorithm, protocol, and/or operation, which may correspond to a data hashing process, unique identifier creation process, or the like. Device fingerprints 134 may be generated as unique identifiers, strings, alphanumeric codes, ML vectors in a vector space (e.g., based on n-degree of dimensionality for n features or attributes of the device parameters), or the like, which uniquely identify a corresponding device based on their device parameters. Other types of device attributes and parameters may include device signals, network signals, browser signals, and/or proprietary signals, which may be requested and/or detected when a device connects to and/or interacts with applications and/or websites of service provider server 120 and/or third-party system 140. For example, computing device 110 may be fingerprinted using device parameters 114 during an initial fingerprinting interaction and/or process for a corresponding account or user identification.

In some embodiments, generating device fingerprints 134 may utilize an AI model and/or engine, such as one or more AI or ML models, NNs, generative AIs, or the like. These models and/or networks may have trained layers based on training data and selected ML features or variables. For example, ML features or variables may correspond to individual pieces, properties, characteristics, or other inputs for an ML model and may be used to cause an output by that ML model once the ML model has been trained using data for those features from training data. ML models may be used for computation and calculation of model scores based on ML layers that are trained and optimized. As such, ML models may be trained to provide a predictive output, such as a score, likelihood, probability, or decision, associated with a particular prediction, classification, or categorization. ML models may also be used to provide output vectors, strings, or other unique identifiers for device fingerprints 134, which may be used for unique device identifications, such as a unique identification of computing device 110 using device parameters 114.

For example, ML models and/or NNs may include deep NNs (DNNs), MLS, large language models (LLMs), generative AI models, or other AI models trained using training data having data records that have columns or other data representations and stored data values (e.g., in rows for the data tables having feature columns) for the features. When building ML models and/or NNs, training data may be used to generate one or more classifiers and provide recommendations, predictions, or other outputs based on those classifications and an ML or NN model algorithm and architecture. The algorithm and architecture for the ML models and/or NNs may correspond to DNNs, ML decision trees and/or clustering, conversational AI models, LLMs, generative AI, and other types of AI, ML, and/or NN architectures. The training data may be used to determine features, such as through feature extraction and feature selection using the input training data. For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the ML models and/or NNs are used to perform a predictive analysis and output, the input data may provide a corresponding output based on the trained classifications.

By providing training data, the nodes in the hidden layer may be trained (adjusted) such that an optimal output (e.g., a classification) is produced in the output layer based on the training data. By continuously providing different sets of training data and/or penalizing the ML models and/or NNs when the outputs are incorrect, the ML models and/or NNs (and specifically, the representations of the nodes in the hidden layer) may be trained (adjusted) to improve its performance in data classifications and predictions. Adjusting of the ML models and/or NNs may include adjusting the weights associated with each node in the hidden layer.

After device fingerprints 134 are generated, such as from the ML models and/or NNs, device fingerprinting platform 130 may provide visitor user identifications through device fingerprints 134, such as when processing visitor identification requests 136. Visitor identification requests 136 may be received from service applications 122 and/or third-party systems 140 based on visitor users and devices interacting with corresponding applications and/or websites. For example, computing device 110 may be used to browse or utilize an application or website associated with service applications 122 or third-party systems 140, but may not login and therefore a user identification may not be established to provide a personalized user experience, offers, and/or notifications including availability and/or uses of computing services provided by service provider server 120 (e.g., transaction processing services on merchant websites or in merchant applications).

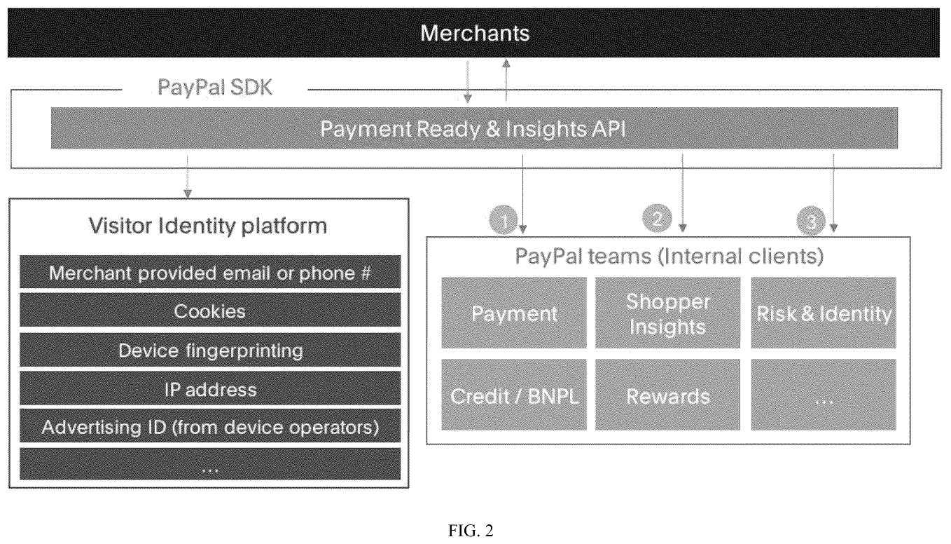

As such, device fingerprinting platforms 130 may receive device parameters 114 as computing device 110 interacts with such an application or website, which may then be processed in a similar manner for device fingerprinting to generate a visitor device fingerprint. Account matching 138 may be performed to process comparisons or matches of the visitor device fingerprint to device fingerprints 134, which may allow for account lookup and identification of a corresponding account or other past user identification. Where multiple accounts are matched, a most recent, most used or active, or other account parameter may be used to select one of the accounts. The account may then be retrieved and personalized actions, such as notifications, recommendations, surfacing or populating of options or computing services, and the like, may be provided to computing device 110 while visiting the application or website. Authentications of the user may be simplified, such as by auto-populating forms or fields in interfaces associated with the account, user, or authentication information and/or usernames, email addresses, phone numbers, or other identifiers, or performing automatic authentications of devices when trusted from device fingerprint matching. This may be done without requiring a direct login, thereby protecting user privacy and security while providing the personalization benefits of user identification. Visitor user identification through device fingerprints is discussed further herein with respect to FIGS. 2-4 below.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, which may include communication of targeted and/or personalized communications, advertisements, marketing, interfaces, processing flows, account services, and other content based on user data and/or accounts after visitor identification through device fingerprints 134. In this regard, service applications 122 may correspond to specialized hardware and/or software used by a user to establish a payment account and/or digital wallet, which may be used to generate and provide user data for the user, as well as process transactions. In various embodiments, financial information may be stored with the account, such as account/card numbers and information. A digital token for the account/wallet may be used to send and process payments, for example, through an interface provided by service provider server 120. The financial information may also be used to establish a payment account and provide payments through the payment account.

The payment account may be accessed and/or used through a browser application and/or dedicated payment application. Service applications 122 may be used to process a transaction, such as using an application/website or at a physical merchant location. In some embodiments, service applications 122 may further be used to provide rewards, incentives, benefits, and/or portions of a cost or price of a transaction based on the transaction being processed for a purchasable item. Service applications 122 may process the payment and may provide a transaction history for transaction authorization, approval, or denial. However, in other situations, service applications 122 may instead provide different computing services, including social networking, microblogging, media sharing, messaging, business and consumer platforms, etc. These computing services may be used by customers and users, such as through third-party systems 140, and therefore those customers and users may receive directed, targeted, and/or personalized content and data based on device fingerprints 134 even without requiring user logins or identifications, which may be provided based on detection of device fingerprints 134. As such, service applications 122 may be interacted with by computing device 110 and used to receive and/or detect device parameters 114 for device fingerprinting and personalization with a corresponding one of accounts 132.

Service applications 122 may provide additional features to service provider server 120. For example, service applications 122 may include security applications for implementing server-side security features, programmatic client applications for interfacing with appropriate application programming interfaces (APIs) over network 150, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 150.

Additionally, service provider server 120 includes database 124. Database 124 may store various identifiers associated with service provider server 120. Database 124 may also store account data, including payment instruments and authentication credentials, as well as transaction processing histories and data for processed transactions. Database 124 may store financial information and tokenization data, as well as transactions, transaction results, and other data generated and stored by service applications 122. Further, fingerprint records 126 may be stored by database 124, which may correspond to records for device fingerprints 134 linked to accounts 132 for data sharing and use with different applications and websites on visitor identification. Although database 124 is shown as residing on service provider server 120 as a database, in other embodiments, other types of data storage and components may be used including cloud computing storage nodes, remote data stores and database systems, distributed database systems over network 150 and/or of a computing system associated with service provider server 120, and the like.

Service provider server 120 may include at least one network interface component 128 adapted to communicate computing device 110, third-party systems 140 and/or other devices, servers, and the like directly and/or over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices. In various embodiments, service provider server 120 may utilize network interface component 128 to communicate with one or more edge networks, edge storage nodes or systems, 5G or other cellular network, devices, and the like for distribution and storage of device fingerprints 134, user segments 136, and the like to provide consent management and enforcement.

Third-party systems 140, which include more generalized content provider systems, may be maintained, for example, by an online merchant, service provider, advertiser, marketing strategist and/or marketing service, or the like which may provide a platform in which targeted communications, services, and offers, such as advertisements or other marketing, use of accounts for account services and data processing, and other personalization may be provided to users based on detection of devices through device fingerprints 134. As such, third-party systems 140 may provide automated operations for conversing with customers or other end users of service provider server 120 through devices, where devices may be fingerprinted and communications then targeted or personalized based on linking device fingerprints 134 to corresponding ones of accounts 132. In this regard, third-party systems 140 includes one or more processing applications, which may be configured to interact with service provider server 120 and/or other devices or systems to provide computing services and targeted and personalized communications.

In this regard, third-party systems 140 may include operations to fingerprint user devices and endpoints that interact with third-party systems 140 or corresponding applications, websites, and/or servers, or provide such data to service provider server 120 for fingerprinting. For example, service provider server 120 may provide an SDK, API endpoints and/or specification, code packages, fingerprinting algorithm or operations, and the like, which may be used for device fingerprinting. For example, an SDK provided by service provider server 120 may be implemented to collect and/or process device attributes and parameters for detected devices visiting the applications or websites of third-party systems 140. The fingerprinting operations provided by or accessible from service provider server 120, which may then be used to fingerprint interacting devices so that devices may be detected and linked to their corresponding ones of accounts 132 and/or other user data. Thereafter, customization and personalization or targeted communications including advertisements and other marketing may be sent to the devices based on accounts 132 and/or other user data.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIG. 2 is an exemplary system architecture for managing and enforcing data privacy consent through device fingerprints, according to an embodiment. The system architecture may include components referenced with regard to system 100 of FIG. 1, such as the components of service provider server 120 interacting with computing device 110 and third-party systems 140 over network 150. In this regard, the system architecture shows representations and interactions of device fingerprinting for visitor identifications with merchants or other third-parties. For example, a service provider may provide a payment ready and insights API or other API via an SDK, which may allow for interaction with a visitor identity platform and other internal clients, applications, and systems. This may allow the merchants or other third-parties to receive benefits from identifying visitor users, as well as provide personalization and streamlined authentication through visitor identification.

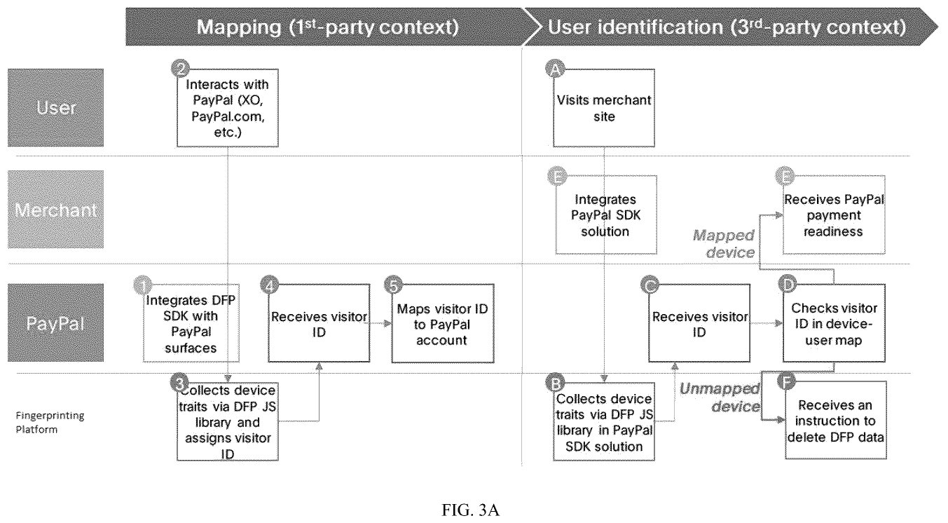

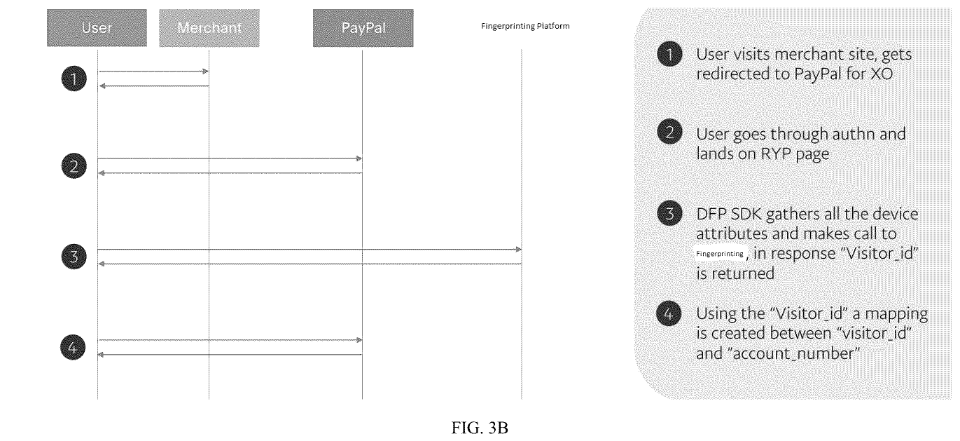

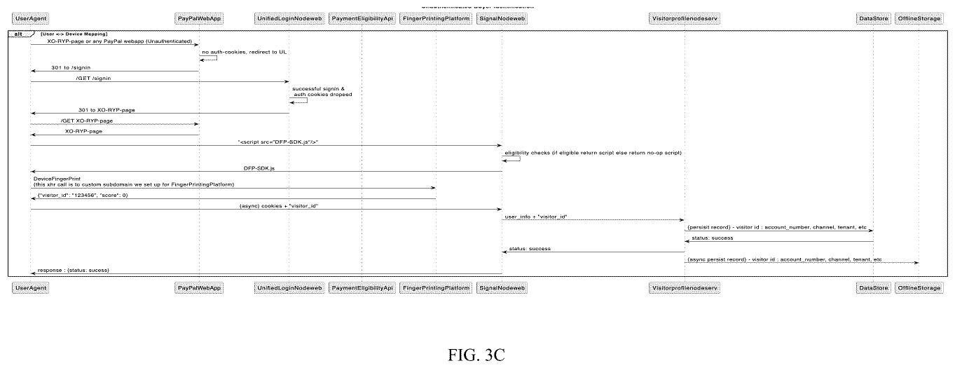

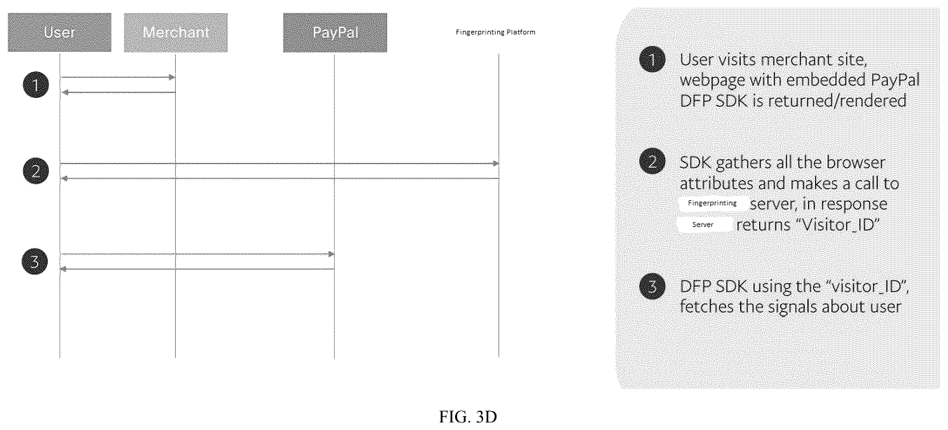

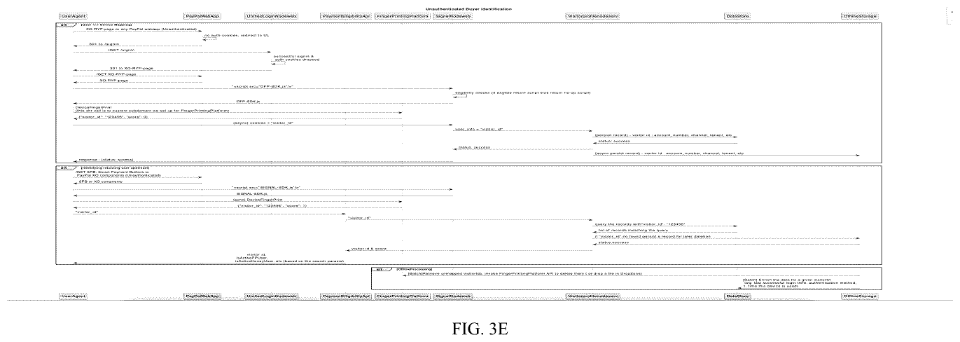

FIGS. 3A-3E are exemplary diagrams of interactions with a device fingerprinting system and framework for online visitor identification, according to an embodiment. FIG. 3A shows the interactions and interactions between the users, service providers, third parties, and fingerprinting platforms for visitor device identification through device fingerprints. This may include initial mapping from a first-party context where a service provider creates a device fingerprint and maps the fingerprint to an account. Thereafter, during user identification when visitor devices and users are detected, this device fingerprint and mapping may be used for identification of the user and account, which may allow for personalization and authentication.

In FIG. 3B, an exemplary onboarding of a user is shown when a user visits a merchant website and is redirected to a service provider, or otherwise lands on the service provider, for account authentication, setup, or the like. This may be done to establish a visitor identifier corresponding to device fingerprint, which may be based on device attributes and parameters. In FIG. 3C, an exchange of API calls to perform the onboarding in FIG. 3B is shown. In FIG. 3D, an exemplary visitor identification of a user is shown when a user interacts with an application or website but has not logged in other otherwise performed a user identification and/or authentication. In FIG. 3E, an exchange of API calls to perform the visitor identification in FIG. 3D is shown.

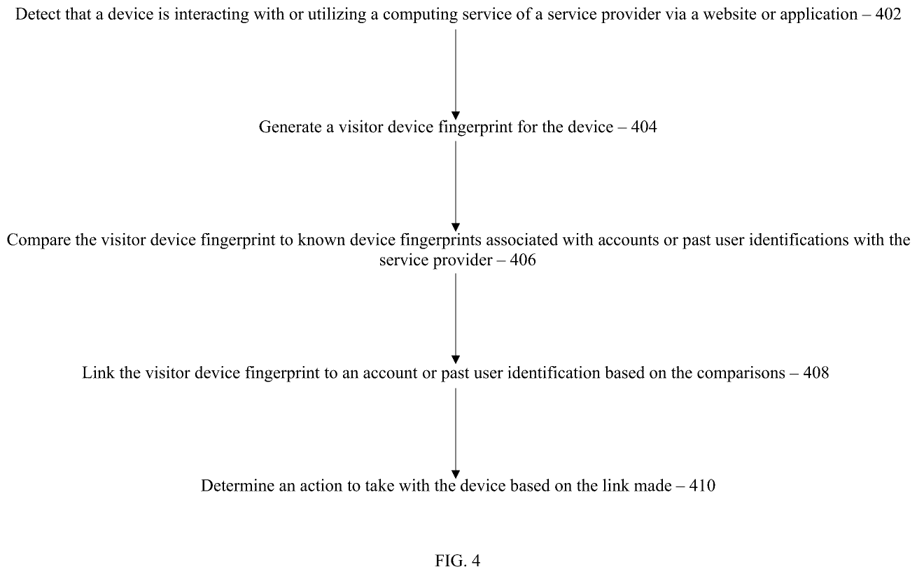

FIG. 4 is a flowchart for a computing framework for online visitor identification through device fingerprints, according to an embodiment. Note that one or more steps, processes, and methods described herein of the flowchart may be omitted, performed in a different sequence, or combined as desired or appropriate and performed by one or more devices, servers, or systems of FIG. 1.

Initially, at step 402 of the flowchart in FIG. 4, a service provider, such as service provider 120 of FIG. 1, detects that a device is interacting with or utilizing a computing service of a service provider via a website or application. For example, a user may visit an internal or external application or website, such as one provided by the service provider or a third-party including merchants. This may be done using computing device 110 by interacting with service applications 122 or third-party systems 140. However, the user may forego logging in, either to remain anonymous, not provide account or user information, or simply by forgetting or when browsing and not actively requiring an account. As such, the user may be a “visitor” for the application or website where the user is not yet identified and therefore personalization and authentication for account and computing services cannot yet be provided.

At step 404, a visitor device fingerprint for the device is generated. For example, device parameters for the computing device usable to generate a digital device fingerprint for the computing device may be obtained when the device is detected as a visitor to the application or website. When interacting with service provider server 120, computing device 110 may provide, or service provider server 120 may detect device parameters 114 for computing device 110, which may be used to uniquely identify computing device 110 through determination and/or computation of a device fingerprint. In this regard, the device parameters may include a device make, a device model, a processor type, a screen resolution, a screen height and/or a screen width, an operating system, a browser type and/or a browser version, an IP address, a MAC address, or the like.

As such, the digital device fingerprint for the computing device may be generated based on the device parameters. To compute the device fingerprint for computing device 110 based on device parameters 114, service provider server 120 may utilize a unique identifier creation algorithm, a hashing algorithm, or a mathematical model. In other embodiments, a NN, ML model, or other AI processing engine and/or model may be used to process input features associated with the device parameters and output a device fingerprint as a vector or other representation of the features, such as a vector of n dimensions represented in a vector space. As such, the digital device fingerprint may uniquely identify computing device 110 when such device parameters are detected. In other embodiments, the digital device fingerprint may have been previously generated and stored, such that the system may then access the previously generated digital device fingerprint.

At step 406, the visitor device fingerprint is compared to known device fingerprints associated with accounts or past user identifications with the service provider. An account lookup process may be performed by service provider server 120 using a mapping of device fingerprints 134 to corresponding ones of accounts 132. Where multiple accounts may be identified, a selection parameter or intelligence may be used, such as a most recently used account or account most commonly used by the device corresponding to the device fingerprint. As such, a query and/or data lookup operation may be performed based on a mapping table and/or key for device fingerprints 134 (e.g., strings, data keys, vectors, etc.).

At step 408, the visitor device fingerprint is linked to an account or past user identification based on the comparisons. Once matching from step 408 is performed, the account may be retrieved and corresponding account and/or user data may be determined. This may allow for determination of specific personalization and/or authentication processes to provide to the corresponding device when being used and/or interacting with a website or an application of the service provider or other third party that utilizes or implements the computing services provided by the service provider. As such, at step 410, an action to take with the device is determined based on the link made. The action may correspond to a user specific communication, alert, recommendation, offer, or the like that may be transmitted or populated to the user through the website or in an application interface. Further, available computing processes and/or features may be surfaced and/or displayed to the user, such as a checkout option with the service provider. Where an authentication may be required for use of the user's account and/or services of the service provider, authentication information may be prefilled or entered into one or more fields or interface elements, such as a username, email address, phone number, or other identifier, thereby simplifying the login and/or authentication process.

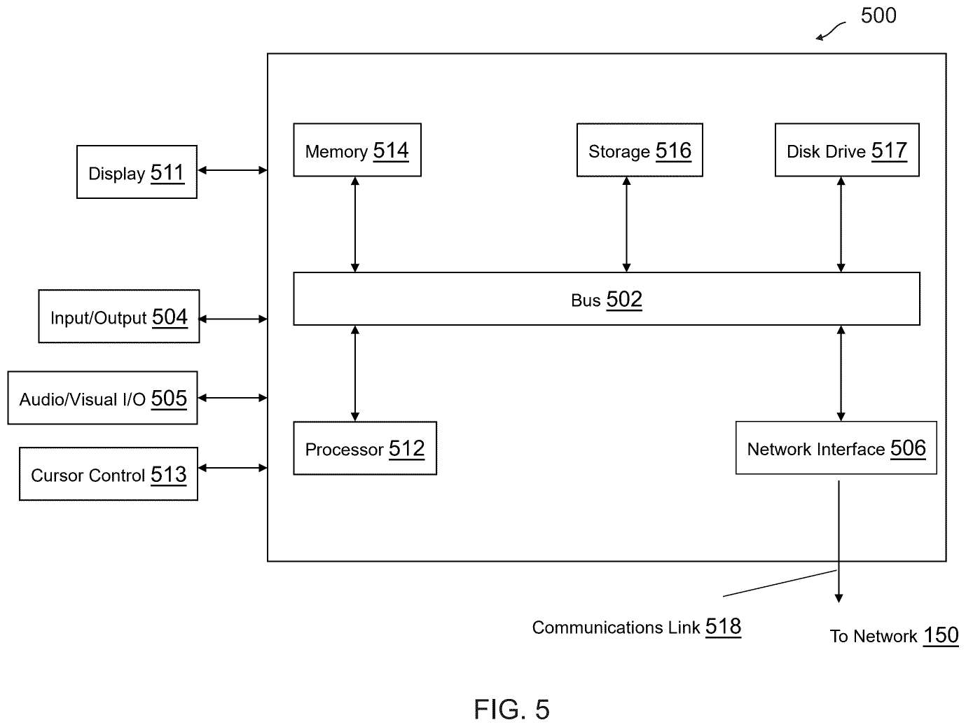

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to execute instructions to cause the service provider system to:
detect a device associated with a user interacting with a website or an application utilizing a computing service provided by the service provider system, wherein the device is logged out of any account on the website or in the application;
generate a visitor device fingerprint for the device based on one or more device parameters for the device and a device fingerprinting technique;
compare the visitor device fingerprint to a plurality of pre-generated device fingerprints from devices previously detected by the service provider system and associated with accounts provided by the service provider system;
link the visitor device fingerprint to an account based on one of the plurality of pre-generated device fingerprints determined from comparing the visitor device fingerprint to the plurality of pre-generated device fingerprints; and
determine an action to take with the user based on the account and one or more interactions by the device with the website or the application.

2. The service provider system of claim 1, wherein comparing the visitor device fingerprint to the plurality of pre-generated device fingerprints comprises:
scoring similarity comparisons of the visitor device fingerprint to each of the plurality of pre-generated device fingerprints; and
selecting the one of the plurality of pre-generated device fingerprints based on a highest scoring one of the similarity comparisons.

3. The service provider system of claim 2, wherein the similarity comparisons include a threshold similarity for a consideration during the selecting, and wherein the selecting comprises selecting between two or more of the plurality of pre-generated device fingerprints having the highest scoring one of the similarity comparisons based on a selection criteria.

4. The service provider system of claim 3, wherein the two or more of the plurality of pre-generated device fingerprints are associated with two or more accounts, and wherein the selection criteria comprise at least one of a most recently used account or a most recently used device for a corresponding device fingerprint.

5. The service provider system of claim 1, wherein the device fingerprinting technique generates unique identifiers from different device parameters detected from at least one of device hardware, device software, or network communications by the device.

6. The service provider system of claim 5, wherein the different device parameters comprise at least one of a device make, a device model, a processor type, a screen resolution, a screen height, a screen width, an operating system, a browser type, a browser version, an Internet protocol (IP) address, or a media access control (MAC) address.

7. The service provider system of claim 1, wherein generating the visitor device fingerprint utilizes a machine learning (ML) model that generates a vector for the visitor device fingerprint based on ML features associated with the one or more device parameters.

8. The service provider system of claim 1, wherein, prior to detecting the device, executing the instructions further causes the service provider system to:
request a consent to digitally fingerprint the device using the device fingerprinting technique; and
fingerprint the device using at least the one or more device parameters.

9. The service provider system of claim 8, wherein executing the instructions further causes the service provider system to:
store a corresponding one of the plurality of pre-generated device fingerprints with the consent and an account identifier for the account.

10. The service provider system of claim 1, wherein the computing service comprises electronic transaction processing provided by the service provider system, and wherein the action comprises providing an offer specific to the user and associated with the electronic transaction processing for a transaction being processed on the website or in the application.

11. A method comprising:
identifying a visitor user is utilizing a website or an application using a device;
determining one or more device parameters for the device;
performing a device fingerprinting of the device that generates a visitor device fingerprint based on the one or more device parameters and a device fingerprinting technique, wherein the device fingerprinting technique generates a unique identifier from processing the one or more device parameters for the device fingerprinting;
comparing the visitor device fingerprint to known device fingerprints from previously identified devices, wherein the comparing includes scoring comparisons of the visitor device fingerprint to the previously identified device fingerprints;
identifying one of the known device fingerprints based on the comparing; and
determining an account associated with the one of the known device fingerprints.

12. The method of claim 11, wherein the comparing is performed using server-side data stored independently from the device by a database of a service provider associated with the website or the application.

13. The method of claim 11, wherein the known device fingerprints are maintained by a computing service of a service provider and are not stored on the previously identified devices by the computing service.

14. The method of claim 11, wherein each of the known device fingerprints are stored by a server database in association with a corresponding one of a plurality of accounts.

15. The method of claim 14, wherein each of the known device fingerprints are stored in response to a consent from the corresponding one of the plurality of accounts.

16. The method of claim 11, further comprising:
providing an access to the account.

17. The method of claim 16, wherein the providing the access to the account comprises:
automatically authenticating the visitor user for the account on the website or in the application.

18. The method of claim 16, wherein the providing the access to the account comprises:
lowering a trust requirement for authenticating the visitor user for the account on the website or in the application; and
requesting an authentication credential for the account based on the lowered trust requirement.

19. A non-transitory machine-readable medium having stored thereon machine-readable instructions executable to cause a machine to perform operations comprising:
determining a user, via a device, is visiting a website or an application that includes a computing service provided by a service provider;
fingerprinting the device using one or more device parameters of the device;
determining a past fingerprinted device correlated with the fingerprinted device within a certainty score threshold;
determining an account associated with the past fingerprinted device; and
providing content to the user on the device while visiting the website or the application based on the account.

20. The non-transitory machine-readable medium of claim 19, wherein the determining he past fingerprinted device is based on server-side data stored independent from the device by the service provider.
